(19) United States
(12) Patent Application Publication
(10) Pub. No.: US 2008/0000721 A1
(43) Pub. Date: Jan. 3, 2008

(54) Ladder safety device

(76) Inventor: Clifton Deal, Mineral Bluff, GA (US)

Correspondence Address: Clifford Kraft, 320 Robin Hill Dr., Naperville, IL, 60540, US

(21) Appl. No.: 11/583,996

(22) Filed: Oct. 19, 2006

Related U.S. Application Data
(60) Provisional application No. 60/728,501, filed on Oct. 20, 2005.

(51) Int. Cl. E06C 7/42

(52) U.S. Cl. 182/109

(57) ABSTRACT

A ladder safety that prevents sideways tipping accidents having a pair of struts extending outwardly and downward from the lower rails of the ladder with the struts making contact with a base surface or the ground. The struts can be clamped or pinned to the ladder, or they can be attached to a horizontal bar or other member that passes through one of the hollow rungs of the ladder. These struts can be telescoping with pins or other devices to allow adjustment. The struts can be fixed or removable. Each of the struts can further include a shoe that contacts the base surface or ground to provide extra stability. The shoe can be angled so that it is flat on the ground at the desired strut angle. A preferred strut angle is between 35 and 50 degrees. A different embodiment of the invention can have a horizontal extension from the side of the ladder with a vertical support on each side.

This application is related to and claims priority from U.S. Provisional patent application No. 60/728,501 filed Oct. 20, 2005. Application 60/728,501 is hereby incorporated by reference.

### BACKGROUND

1. Field of the Invention

The present invention relates generally to safety devices and more particularly to a ladder safety device that can make any ladder safe from sliding sideways.

2. Description of the Problem Solved

Ladders, especially extension ladders, are very dangerous devices. Numerous falls occur each year that are the result of a ladder sliding sideways. Normally a ladder is placed up against a structure or up over the eve of a building roof. Ladder feet generally keep the base of the ladder from moving in or out; however, there is normally absolutely nothing to keep the top of the ladder from slipping sideways except the small amount of friction where the upper part of the ladder meets the structure.

A recently documented accident is typical of the danger of extension ladders. A contractor was descending an extension ladder that gave him access to a garage roof. The height of the roof eve was 12 feet above a concrete driveway. The contractor tried to descend with a paint can hanging from his left hand and a shingle hanging from his right hand. As he descended, the end of the shingle got between his right foot and the ladder rung. His foot slipped completely off the rung. As he started to fall, he dropped the paint can and grabbed the right ladder rail. If the ladder had not slipped, he could have slid down the right ladder rail; however, since his center of gravity was to the right of the ladder, a lever arm was created, and the ladder began to slip to the right. As soon as the ladder slipped beyond the eve of the roof, it fell causing the contractor to fall directly on his back on the concrete from a height of around 4-5 feet. Serious injuries resulted.

What is very badly needed is a simple device that works on all types of even and uneven ladder surfaces that will positively prevent a ladder from slipping sideways no matter what type of lever arm or off-center force may be present.

### SUMMARY OF THE INVENTION

The present invention relates to a ladder safety that prevents sideways tipping accidents, the device having a pair of struts extending outwardly and downward from the lower rails of the ladder with the struts making contact with a base surface or the ground. The struts can be clamped or pinned to the ladder, or they can be attached to a horizontal bar or other member that passes through one of the hollow rungs of the ladder. These struts can be telescoping with pins or other devices to allow adjustment. The struts can be fixed or removable. Each of the struts can further include a shoe that contacts the base surface or ground to provide extra stability. The shoe can be angled so that it is flat on the ground at the desired strut angle. A preferred strut angle is between 35 and 50 degrees. A different embodiment of the invention can have a horizontal extension from the side of the ladder with a vertical support on each side.

### DESCRIPTION OF THE FIGURES

FIG. 1 shows a strut-type embodiment of the present invention.

FIG. 2 shows a leg-type embodiment of the present invention.

Several drawings and illustrations have been presented to better aid in understanding the present invention. The scope of the present invention is not limited to what is shown in the figures.

### DESCRIPTION OF THE INVENTION

The present invention relates to a safety attachment that works with any ladder that positively prevents the ladder from slipping sideways. The invention works by widening the effective base of the ladder with struts or legs, and thereby moving the fulcrum of any lever arm that might develop from an off-centerline load.

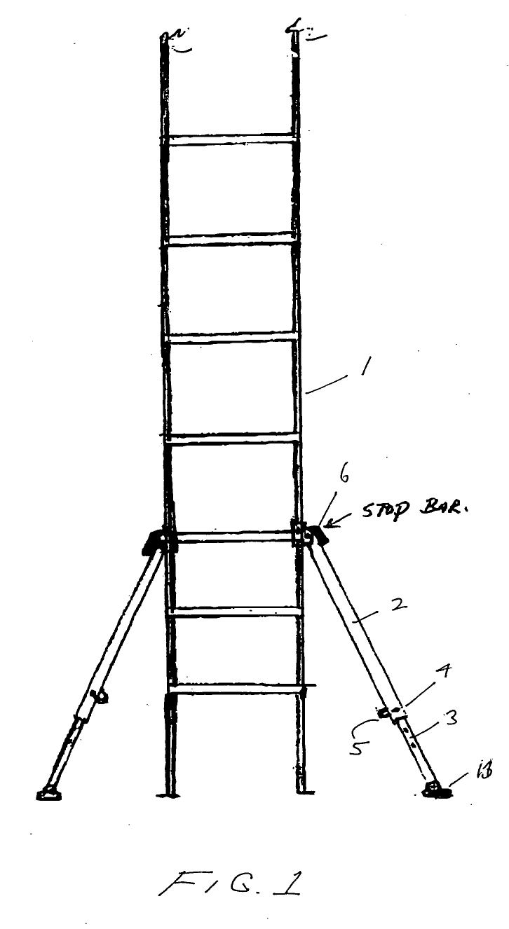

Turning to FIG. 1, an embodiment of the present invention is seen that operates on the principle of struts. Here a ladder 1 is prevented from tipping or slipping sideways a telescoping strut 2. The bottom part 3 can telescope out of the top 2. A pin 5 can be placed through a set of aligned pin holes 4 to lock the lower part to match the height of the base soil, driveway, etc. where the strut is positioned. A foot 13 can be rubber, metal or any other material and can optionally contain anti-slip grooves. A stop bar 6 or any other type of connection attaches the strut 2 to the ladder 1. Normally a rod or bar runs through a hollow rung on the ladder side-to-side to attach the struts on each side; however, any manner of attaching the strut 2 to the ladder 1 is within the scope of the present invention. The struts can be removable or fixed and can telescope. The embodiment of FIG. 1 is very useful because the two struts do not have to be set to the same length. This allows the apparatus to be used on uneven or non-level surfaces.

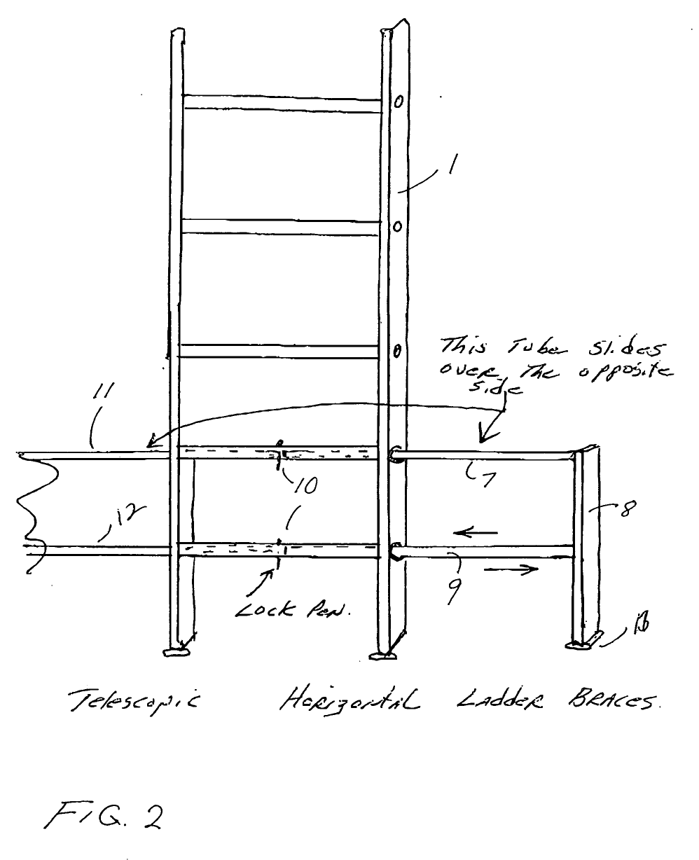

FIG. 2 shows an alternate embodiment of the present invention. Here a top bar 7 and bottom bar 9 run through the ladder rungs and telescope into a mating bars 11 and 12 from the other side. A vertical portion 8 with a foot 13, similar to the foot in FIG. 1, extends to the base surface. This embodiment is most useful for flat base surfaces such as driveways, etc. Lock pins 10 can lock the extended verticals 8 to a fixed distance from the ladder 1.

The embodiments of the invention shown in FIGS. 1 and 2 are very useful for increasing the safety of working on a ladder, especially a long extension ladder (a longer ladder creates more of a lever arm for any off-centerline load).

While several descriptions and illustrations have been provided to better aid in understanding the present invention, a person of skill in the art will realize that many changes and variations are possible. Each of these changes and variations is within the scope of the present invention.

I claim:

1. A ladder safety device comprising a pair of struts extending outwardly and downward from the lower rails of a ladder, said struts making contact with a base surface or ground, wherein said struts prevent said ladder from tipping sideways.

2. The ladder safety device of claim 1 wherein said struts are telescoping.

3. The ladder safety device of claim 1 wherein said struts are removable.

4. The ladder safety device of claim 1 wherein each of said struts further includes a shoe.

5. The ladder safety device of claim 1 further comprising a horizontal member passing through a rung of said ladder, said horizontal member being mechanically coupled to each of said struts.

6. A ladder safety device comprising at least one horizontal member extending laterally outward from a ladder, said horizontal member coupled to at least one vertical member that extends downward and contacts a base surface, whereby said members prevent said ladder from tipping sideways.

7. The ladder safety device of claim 5 further comprising a second horizontal member extending laterally outward from said ladder.

8. A method of preventing ladder tip-over accidents comprising the steps of:
attaching a left strut to a left vertical rail of a safety ladder, said left strut forming an acute angle with said left rail, said left strut contacting a base surface or ground;
attaching a right strut to a right vertical rail of a safety ladder, said right strut forming an acute angle with said right rail, said right strut also contacting a base surface or ground;
whereby said left and right struts prevent said ladder from tipping sideways.

9. The method of claim 8 wherein said left and right strut are coupled to a horizontal member that passes through a rung of said ladder.

10. The method of claim 8 wherein said left and right struts each have flat shoe members on their distal ends.

11. The method of claim 8 wherein said left and right struts are telescoping.
